(19) United States
(12) Patent Application Publication
(10) Pub. No.: US 2007/0132583 A1
(43) Pub. Date: Jun. 14, 2007

(54) Monitoring signals of radio frequency identification systems

(76) Inventor: Patrick Joseph Sweeney II, Philomont, VA (US)

Correspondence Address: JUSTIN GRAY, 12003 WALNUT BRANCH RD., RESTON, VA, 20194, US

(21) Appl. No.: 11/164,862

(22) Filed: Dec. 8, 2005

(51) Int. Cl. G08B 13/14

(52) U.S. Cl. 340/572.1; 340/568.1; 705/22

(57) ABSTRACT

A system and method for optimally placing radio frequency identification (RFID) antennas. The system varies the placement of RFID tag and interrogator antennas with respect to each other and a stationary object or objects. A signal generator sends a known reference signal to the one or more RFID interrogator antennas. The signal is received by the one or more RFID tag antennas and is displayed upon an oscilloscope, spectrum analyzer or other multipurpose signal measuring device. By this method, the system finds the optimal placement of the antennas with respect to each other and the object or objects.

### BACKGROUND OF INVENTION

Radio frequency identification (RFID) systems allow for the identification of objects at a distance and out of line of sight. They are comprised of transponders called radio frequency (RF) tags and RF interrogators (also called readers). The tags are generally smaller and less expensive than interrogators, and are commonly attached to objects such as product packages in stores. When an interrogator comes within range of an RF tag, it may provide power to the tag via a querying signal, or the RF tag may use stored power from a battery or capacitor to send a radio frequency signal to be read by the RFID interrogator.

RF tags may consist of single integrated circuits, circuits and antennas, or may incorporate more complex capabilities such as computation, data storage, and sensing means. Some examples of a few of the various categories of RFID tags include the following: passive tags that acquire power via the electromagnetic field emitted by the interrogator, semi-passive tags that respond similarly, but also use on-board stored power for other functions, active tags that use their own stored power to respond to an interrogator's signal, inductively coupled tags that operate at low frequencies and short distances via a coil antenna, single or dipole antenna-equipped tags that operate at higher frequencies and longer distances, read-write tags that can alter data stored upon them, full-duplex or half duplex tags, collision arbitration tags that may be read in groups, or non-collision tags that must be read individually.

RFID systems generally consist of RFID tags, RFID interrogators and middleware computing devices. Downstream processing of RFID signal information such as EPC numbers, GTINs, or UID numbers usually occurs in two stages. Tag responses are and converted to a standard packet form by the reader and sent to the middleware device. The middleware device is responsible for processing the raw information into a useful form. For instance, a reader may send many identical packets when a tag attached to an object moves along a conveyor belt past an interrogator. The middleware reduces the chatter of the interrogator to a concise and structured stream of unique packets. These packets are then typically sent to an enterprise application that actually processes the data. Examples of such applications include those that perform inventory management, supply chain management and analysis, or purchase and backorder handling.

RFID systems present a number of advantages over other object marking and tracking systems. A radio frequency interrogator may be able to read a tag when it is not in line of sight from the interrogator, when the tag is dirty, or when a container encloses the tag. RFID systems may identify objects at greater distances than optical systems, may store information into read/write tags, may operate unattended, and may read tags hidden from visual inspection for security purposes. These advantages make RFID systems useful for tracking objects. They are being adopted for use in retail stores, airports, warehouses, postal facilities, and many other locations. RFID systems will likely be more widely adopted as the price of tags and interrogators decreases.

As organizations strive to adopt RFID systems for tracking objects, they face challenges imposed by the nature of the objects they handle and the environments in which those objects are processed. Radio frequency signals are reflected, refracted, or absorbed by many building, packaging, or object materials. Moving people, vehicles, weather and ambient electromagnetic radiation can also effect the performance of RFID systems. Compounding the situation is a growing diversity of choices among RFID systems and components with dimensions such as cost, range, and power consumption. An RFID tag may deliver varying performance depending upon its orientation and location upon or within a package, its distance from a reader and the frequency at which it operates. Often companies must purchase and evaluate systems through trial and error, a time-consuming and costly process. Radio frequency design and testing software, RF site surveys and prototype systems can assist the process, but these approaches do not address the problem of complex object materials, changing object materials, and the wide variety of RFID tags available.

In a typical RFID system, a continuous stream of RFID tags attached to objects moves past an interrogator or interrogators. For example, a warehouse may have interrogators at its entrances. Pallets brought into and out of the warehouse have tags attached to them providing information about the pallets' contents. Interrogators, antennas, tags, networking and computing equipment are all subject to failure, potentially impairing the ability of the RFID system to properly track the contents of the warehouse. A need exists for a method and apparatus for monitoring and analyzing signals within an RFID system.

U.S. Pat. No. 6,104,291 discloses a method and apparatus for testing (and/or writing information to) RFID tags using wireless radio frequency communication. The apparatus differs from this invention in that it does not provide a continuous indication of interrogator performance throughout the path followed by RFID-tagged objects within a real world RFID system.

U.S. Pat. No. 5,999,861 discloses a method and apparatus for testing RFID tags. The apparatus differs from this invention in that while it moves RFID tags with respect to an RFID interrogator, it tests the performance of a number of tags within the same interrogator field. The apparatus also differs from this the invention disclosed herein by testing tags rather than their signals within the environment of an RFID system or systems. The invention disclosed herein may provide indications of the performance of different tags, but also provides a continuous indication of interrogator performance throughout the path followed by RFID-tagged objects.

U.S. Pat. No. 5,929,760 discloses an RFID conveyor antenna system in which tags are moved along a conveyor belt past an RFID interrogator. The method differs from this invention in that it only addresses the performance of tags under these circumstances, and it does not does not determine or assist in determining the optimal placement of RFID tag antennas with respect to interrogators or objects. The invention disclosed herein also provides a continuous indication of interrogator performance throughout the path followed by RFID-tagged objects.

### SUMMARY OF INVENTION

This invention relates to a method and apparatus for monitoring signals within a radio frequency identification (RFID) system. The apparatus comprises a case, one or more antennas, and a spectrum analyzer. The case allows for the placement of one or more antennas with respect to the case, other objects, and the case's environment. The spectrum analyzer acquires the signal from the antenna or antennas mounted upon the case. By varying the position of the case, a user of the system may make acquire information regarding signals presented to the one or more antennas mounted upon the case as the case moves through an environment containing one or more external RFID interrogators and other objects. This information may be employed within a larger management system for enhanced RFID system performance.

In an embodiment of the apparatus, a case contains a spectrum analyzer. An antenna mounted on an exterior side of the case sends the signals it receives to the signal analyzer. Within an RFID system, such as that employed at a warehouse gate, the case may be handled alone or with a group of other objects, in the same way that other RFID-tagged objects are handled. The antenna mounted upon the case receives a signal or signals from the antenna or antennas of the RFID interrogator or interrogators of the RFID system as the case moves through the system. For instance, the case might be mounted upon a pallet of cartons upon a loading dock. As a forklift raises the pallet and drives it through the gate, the case comes within range of the RF signals emitted by the antenna or antennas of the RFID interrogator or interrogators mounted upon the warehouse gate. The spectrum analyzer may monitor the signal for later analysis or perform real-time analysis upon it. Later, the pallet or the individual case might be placed upon a conveyor belt that moves past an interrogator. As the case moves past the radio frequency field emitted by the stationary interrogator, the antenna mounted upon the case receives the signal and transmits it to the signal analyzer within the case. When the case leaves the warehouse, the antenna mounted upon it receives the signals from several interrogators mounted upon the gate and transmits them to the signal analyzer for storage and analysis. Once the case has traveled completely through the system, the information contained within it may be replayed, uploaded to a larger system or analyzed within the confines of the spectrum analyzer. This information may be employed within a larger management system for enhanced RFID system performance.

In another embodiment of the invention, the case captures the signals of more than one antennas mounted upon the exterior of the case. This presents the advantage of testing different locations upon the case and different orientations of antennas.

In another embodiment, the antenna or antennas mounted upon the exterior of the case are mounted within a replaceable carriage. To test a different antenna, a user of the system can detach the antenna carriage and its associated antenna and replace it with another.

In another embodiment, the antenna or antennas mounted upon the exterior of the case may be moved and reattached to any point and orientation within or upon the case.

In another embodiment, a GPS system or other location-sensing system stores position data synchronously with the signal data from the antennas.

The foregoing general description and the following detailed description are exemplary and explanatory only and do not restrict the claims directed to the invention. The accompanying drawings, which are incorporated in and constitute a part of this specification, illustrate some embodiments of the invention and together with the description, serve to explain the principles of the invention but not limit the claims or concept of the invention.

### BRIEF DESCRIPTION OF DRAWINGS

FIG. 1 is a diagram illustrating an embodiment of the apparatus.

FIG. 2 is a flow chart illustrating the method by which the embodiment of FIG. 1 is used.

### DETAILED DESCRIPTION

The following detailed description of embodiments of this invention and the attached figures are intended to provide a clear description of the invention without limiting its scope.

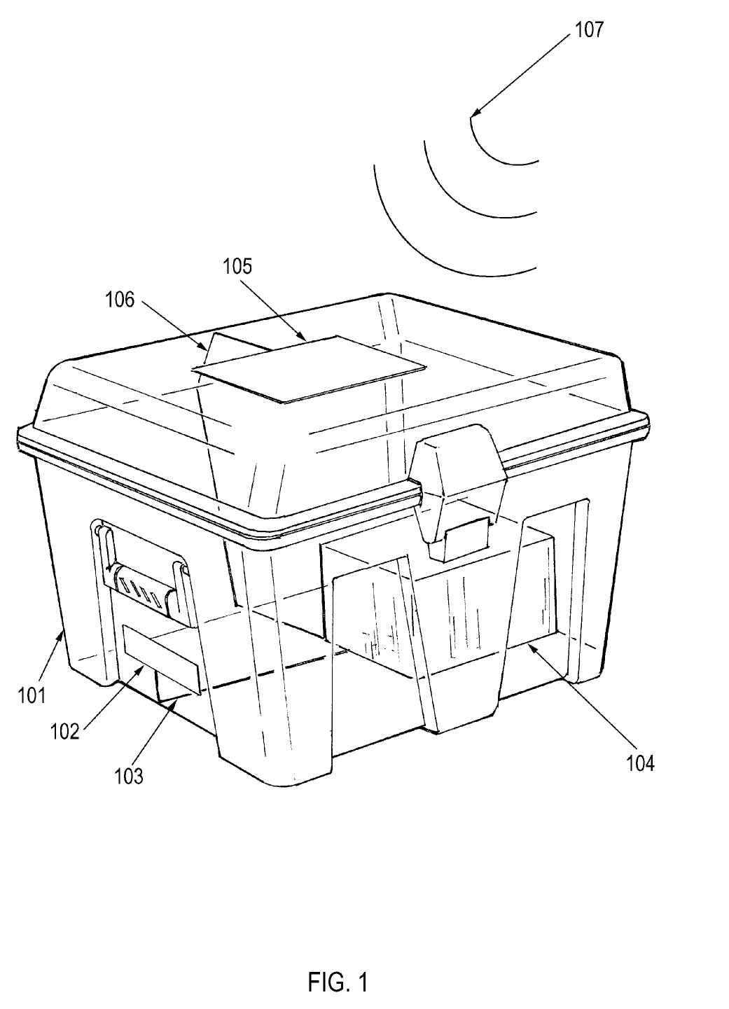

FIG. 1 is a diagram illustrating the overall structure of an embodiment of the system. Case 101 is made of materials such as acrylic plastic that are relatively transparent to radio waves in the frequency of the RFID tags and interrogators to be tested. An example of such a material is acrylic plastic.

RFID antennas 102 and 105 receive the signals 107 emitted by an interrogator or interrogators external to the case. As the case moves through the environment, for example, on a pallet born by a forklift, for example, the signal strength to antennas 102 and 105 varies. The signals received by antennas 102 and 105 are transmitted by wires 103 and 106 to spectrum analyzer 104. Spectrum analyzer 104 may be replaced by other signal measuring devices such as oscilloscopes, or multi-purpose signal measuring devices. Additionally, each antenna may be equipped with its own spectrum analyzer or other recording means. Spectrum analyzer 104 may store the information for later playback or may transmit it to an external device via a wireless transmission means. Through this method, the apparatus creates a map of the radio frequency emissions of the environment through which the case moves. This information may be employed within a larger management system for enhanced RFID system performance.

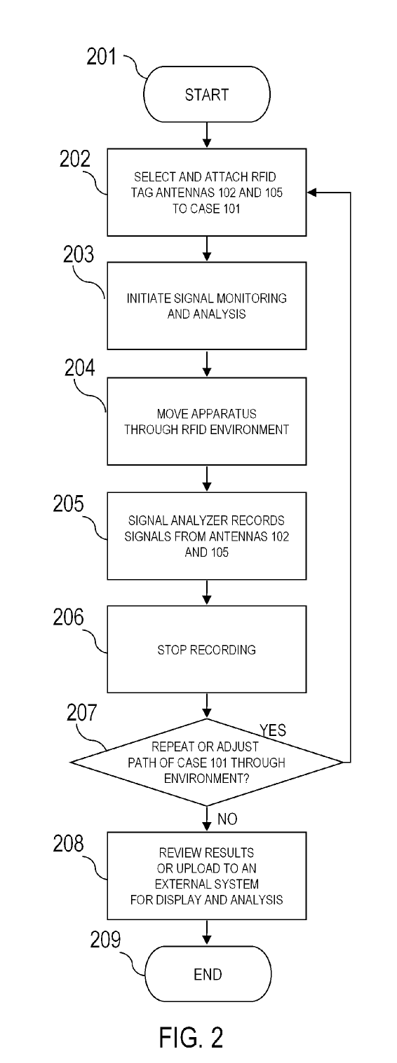

FIG. 2 is a flow chart illustrating the method by which the embodiment of FIG. 1 is used. At 201, use of the apparatus is initiated. At 202, the user of the system selects and attaches antennas 102 and 105 to case 101. The user might also adjust the orientation and location of the antennas. At 203, the user initiates signal monitoring and analysis. At 204, the apparatus is moved through the RFID system environment. For example, the case might be mounted upon a pallet of cartons upon a loading dock. As a forklift raises the pallet and drives it through the gate, the case comes within range of the RF signals emitted by the antenna or antennas of the RFID interrogator or interrogators mounted upon the warehouse gate. The antennas 102 and 105 receive the signal or signals emitted by the gate antenna or antennas. At 205, the signal analyzer records the signals from antennas 102 and 105. Later, the pallet or the individual case might be placed upon a conveyor belt that moves past an interrogator. As the case moves past the radio frequency field emitted by the stationary interrogator, the antenna mounted upon the case receives the signal and transmits it to the signal analyzer within the case. Still at 205, the signal analyzer records the signals from antennas 102 and 105. When the case leaves the warehouse, the antenna mounted upon it receives the signals from several interrogators mounted upon the gate and transmits them to the signal analyzer. Still at 205, the signal analyzer records the signals from antennas 102 and 105. At 206, the user stops recording. At 207, the user makes a determination to repeat the process, along the same path or a different path through the RFID system environment, or to proceed to 208. If the process is to be repeated, the user begins again at 202. Otherwise, at 208, the user may review results of the signal monitoring and analysis, or upload to an external system for display an analysis. Operation concludes at 209.

What is claimed is:

1. An apparatus for monitoring signals within a radio frequency identification (RFID) system comprising:
a case;
one or more RFID interrogator antennas; and
one or more signal measuring devices selected from the group consisting of oscilloscopes, spectrum analyzers, and multi-purpose signal measuring devices, connected to the one or more RFID interrogator antenna or antennas held by the case such that the information from the signal or signals received by the one or more or antennas may be monitored.

2. An apparatus according to claim 1 wherein the one or more RFID interrogator antennas are mounted within an interchangeable carriage that facilitates the exchange of an RFID interrogator antenna for another of different specifications.

3. An apparatus according to claim 1 wherein the signal information monitored is transmitted to an external device once it is gathered.

4. An apparatus according to claim 1 wherein the signal information monitored is transmitted to an external device in real time via a wireless connection.

5. An apparatus according to claim 1 wherein the signal information monitored is analyzed in real time.

6. An apparatus according to claim 1 wherein the antennas are of different types.

7. An apparatus according to claim 1 wherein a GPS system or other location-sensing system stores position data synchronously with the signals received by the one or more antennas.

8. An apparatus according to claim 7 wherein the location-sensing system is comprised of a GPS tracking device.

9. An apparatus according to claim 1, wherein the one or more signal measuring devices is selected from the group consisting of oscilloscopes, spectrum analyzers, and multi-purpose signal measuring devices.

10. An apparatus according to claim 1 wherein the signal information is displayed external to the case in real time via a transparent display panel.

11. Using an apparatus for monitoring signals within a radio frequency identification (RFID) system comprising: a case, one or more antennas; and one or more signal measuring devices, and multi-purpose signal measuring devices, connected to the one or more RFID interrogator antennas held by the case such that the signal or signals received by the one or more antennas may be monitored, a method comprising:
moving the case through the environment of an RFID system; and
reviewing the recorded signals via the display of the one or more signal measuring devices.

12. The method of claim 11 wherein the apparatus is moved through the environment of the RFID system multiple times along the same path.

13. The method of claim 11 wherein the case is moved through the environment of the RFID system multiple times along different paths.

14. The method of claim 11 wherein the recorded signals are transmitted to an external system via a serial, USB, Firewire, ethernet, or other computer interface connection.

15. The method of claim 11 wherein the recorded signals are transmitted to an external system via Bluetooth, 802.11, or other wireless interface.

16. The method of claim 11 wherein the case is placed at a stationary location within the environment of the RFID system.

17. The method of claim 11 wherein the signal measuring device is selected from the group consisting of oscilloscopes, spectrum analyzers, and multi-purpose signal measuring devices.
